(19) United States
(12) Patent Application Publication
(10) Pub. No.: US 2013/0344219 A1
(43) Pub. Date: Dec. 26, 2013

(54) LOW-BACTERIA LOW-HEAT WHOLE MILK POWDER

(71) Applicant: DMK Deutsches Milchkontor GmbH, Bremen (DE)

(72) Inventor: Sven-Rainer Döring, Zeven (DE)

(21) Appl. No.: 13/923,520

(22) Filed: Jun. 21, 2013

(30) Foreign Application Priority Data
Jun. 26, 2012 (EP) 12 173540

(51) Int. Cl. A23C 9/16

(52) U.S. Cl. CPC A23C 9/16
USPC 426/588; 426/471

(57) ABSTRACT

A process for the production of low-bacteria milk powders having a whey protein nitrogen index (WPNI) of at least 2 is suggested, wherein

(a) solids are removed from raw milk in a process known in itself, then the cream is separated,
(b) the skim milk such obtained is subjected to microfiltration,
(c) the permeate such obtained is pasteurized,
(d) the pasteurized permeate such obtained is concentrated to a dry mass of from 30 to 50% by weight and the retentate is discarded,
(e) the concentrate such obtained is subjected to thermal treatment for a period of at least 15 seconds at a temperature of at least 72° C., and
(f) the thermally treated product is processed to a dry powder.

### AREA OF THE INVENTION

The invention relates to the area of dairy products and concerns a new method of production of low-bacteria milk powders with a high whey protein nitrogen index (WPNI).

### STATE OF THE ART

To produce low-bacteria milk powders, for example, already pasteurized skim milk with a dry mass of about 9% is evaporated to a concentration of about 40%. However, the concentrates still contain a large quantity of thermo-resistant bacteria and spores, which particularly originate from the maize silage fed to the cows, and which end up in the raw milk as a result of insufficient cowshed hygiene. For this reason it has been necessary to subject the concentrates to high-heat treatment before spraying, by means of which the bacteria and spores are quantitatively destroyed, yielding a bacteria-free product of high quality.

Still, high-heat treatment does not only affect the bacteria and spores; also the valuable whey proteins are completely, or to a very large part, denatured, which adversely changes the product in its functionality and nutrition physiology. Whey proteins belong to the albumins and globulins; those particularly include the alpha-Lactalbumin and beta-Lactoglobulin, serum albumin, proteose peptone and the immunoglobulins. From a nutrition-physiological perspective, whey proteins are high-value milk constituents, which are specifically used to build muscle, for example, in protein supplements. While untreated skim milk indicates a so-called whey protein nitrogen index (WPNI) as a parameter for its whey protein contents of above 6, specifically of 6.1, this value falls below 1 during conventional ultra-high heat treatment, which is extremely undesired.

An alternative therefor might be to perform the thermal treatment at lower temperatures, for example, at 70° C. instead of above 100° C. In fact, the products such obtained indicate a WPNI of above 5, however, the bacterial contamination is so high that products are obtained which are, at best, difficult to market.

It was, therefore, the task of the present invention to provide milk powders, namely, both skim milk powders and whole milk powders, which are either bacteria-free or low-bacteria—as obtained only after high-heat treatment to this date—and showing a high WPNI of at least 2, particularly, at least 4 and specifically from 5.5 to 6, as obtained using low-heat methods, although these two parameters have always run in opposite directions. In addition, it was intended that this process is performed with a low technical effort.

### DESCRIPTION OF THE INVENTION

The subject-matter of the invention is a process for the production of low-bacteria milk powders with a whey protein nitrogen index (WPNI) of at least 2, particularly, at least 4, and specifically 5 to 7, wherein
(a) solids are removed from raw milk in a method known in itself, the cream is separated,
(b) the skim milk such obtained is subjected to microfiltration,
(c) the permeate such obtained is pasteurized,
(d) the pasteurized permeate such obtained is concentrated to a dry mass of from 30 to 50% by weight, and the retentate is discarded,
(e) the concentrate such obtained is subjected to thermal treatment for a period of at least 15 and, preferably, from 15 to 20 seconds at a temperature of at least 72 and, preferably, from 72 to 80° C., and
(f) the thermally treated product such obtained is processed to a dry powder.

Surprisingly it was found that the separation of the bacteria from the milk can be achieved quantitatively by microfiltration thus not requiring a subsequent ultra-high heat treatment any more. Pasteurization may, in principle, be carried out before filtration; however, with regard to a possibly complete degermination, downstream pasteurization is clearly preferred. The present invention, however, explicitly includes this alternative. In case a warm filtration is performed, it is recommended to design the process such that one microfiltration station each is operated and the other one is cleaned.

### BRIEF DESCRIPTION OF THE DRAWINGS

The present invention will be described in greater detail with reference to the accompanying drawings in which

FIG. 1 illustrates a schematic comparison of examples V1, V2 and 1 infra in a flow chart (HH SM=High Heat Skim Milk; LH SM=Low Heat Skim Milk), and

FIG. 2 illustrates production of low-bacteria Low Heat Skim Milk (LH SM) and Low Heat Whole Milk (LH WM) powders in a flow chart (UHE=Ultra-high heating device).

### DESCRIPTION OF THE PREFERRED EMBODIMENTS

To heat up the milk concentrate to a temperature at which it can be sprayed, temperatures in the range of 70° C.—where whey proteins are not denaturing yet—are sufficient. Technically, it is quite simple to carry out this process, and it supplies the desired low-bacteria product with a high WPNI. The following Table A summarizes the typical specification requirements for a low-bacteria milk powder and the results obtained using the process according to the invention:

TABLE A
Specification of a low-bacteria powder

| | | Require- | |
|---|---|---|---|
| Type of bacteria | Method | ment | Invention |
| Mesophile spores | 10 min 80° C./ | max. 500/g | 2000/g |
| | 30° C. | | |
| Thermophile spores | a) 10 min 80° C./ | max. 500/g | 3000/g |
| | 55° C. | | |
| | b) 30 min 100° C./ | | |
| | 55° C. | | |
| Bacillus Cereus | 10 min 80° C./ | <10/g | <100/g |
| | 30° C. selective | | |
| | medium | | |
| Thermophile | 55° C. | max. 500/g | 4000/g |
| bacteria | | | |
| Sulfite-reducing | 10 min 80° C./ | max. 10/g | <10/g |
| spores | 37° C. (MPN | | |
| | selective broth) | | |
| Clostridium | 10 min/80° C. | max. 10/g | <10/g |
| perfringens | | bis neg/g | |
| Salmonella | LFGB § 64 modf. | neg in 750- | neg in 750- |
| | | 1500 g | 1500 g |
| Enterobacter sakazakii | Selective medium | neg in 375- | neg in |
| | | 750 g | 375 g |

### Pasteurization

The thermal treatment of the raw milk is preferably performed in heat exchangers, whereby specifically plate heat exchangers have proved to be particularly suitable. There is a temperature gradient at the heat exchangers, which, however, is selected such that the raw milk is heated to a temperature of from about 70 to 80° C. and, more particularly, from about 72 to 74° C. for a residence time of a minimum of 20 and a maximum of 60 seconds, preferably, about 30 seconds.

The separation of solids (“cheese fines”) and the skimming of a fat content of about 4% by weight is usually carried out in a downstream component, preferably, a separator. Said components are adequately known from the state of the art. Separators of the company GEA Westfalia Separator GmbH, which allow the joint or single use of both steps (http://www.westfaliaseparator.com/de/anwendungen/molkereitechnik/milch-molke.html), are widely used in the dairy industry. Corresponding components have been disclosed, for example, in DE 10036085 C1 (Westfalia), and are perfectly known to one skilled in the art. Thus no explanations are needed on how to carry out these process steps, as they are understood to be part of the general specialist knowledge.

### Microfiltration

Microfiltration is a process for substance removal. The essential difference between microfiltration and ultrafiltration lies in the different pore sizes and the different membrane structure as well as in the materials and filter materials involved. A filtration through membranes having a pore size of <0.1 μm is usually referred to as ultrafiltration, while a filtration using pore sizes of >0.1 μm is usually referred to as microfiltration. In both cases purely physical, i.e., mechanical membrane separation methods, which apply the principle of mechanical size exclusion, are concerned: all particles in the fluids, which are larger than the membrane pores, are held back by the membrane. The driving force in both separation methods is the differential pressure between the inlet and the outlet of the filter area which is between 0.1 and 10 bar. The filter area material may consist of—depending on the area of application—stainless steel, synthetic material, ceramic or textile fabric. Filter elements appear in different forms: candle filters, flat membranes, spiral coil membranes, bag filters and hollow fibre modules; all of them are principally suitable within the meaning of the present invention.

In dairy technology there has been a prejudice according to which pore diameters should not be less than a value of 0.5 μm to separate microorganisms from raw milk. However, this invention includes the insight that a diameter in the range of from 1.1 to even 2 μm and, preferably, 1.3 to 1.5 μm is completely sufficient for the production of Grade “A” raw milk if the majority of thermo-labile bacteria has been separated before by a corresponding thermal treatment. The combination of this comparably larger pore diameter with a microfiltration device, which essentially comprises a ceramic membrane, solves the problem of frequent clogging at the same time.

Furthermore, there is a prejudice according to which the separation of germs using filtration steps requires temperatures of at least 55° C., as only under these conditions sufficient flux rates may be achieved, while at temperatures of, for example, 20 to 30° C. only flux values of a maximum of 100 l/m²h are achieved. However, filtration carried out in warm conditions has the essential disadvantage that, after 4 hours of filtration time, the thermo-resistant germs and spores start to grow through the membranes and proliferate in the permeate. Within the scope of the process according to the invention, a particular advantage of the process according to the invention thus consists in carrying out the filtration in cold conditions, i.e., at 20 to 30° C., as this prevents the growing through of the bacteria and still surprisingly achieves a flux rate of from 200 to 300 l/m²h.

### Thermal Treatment and Drying

During microfiltration a permeate is obtained from which bacteria and spores have been completely, or at least mainly, removed, which is further processed, discarding the retentate containing the bacteria mud. The permeate is subsequently subjected to thermal treatment at temperatures from 70 to 80 and, preferably, at 72 to 75° C. to heat up the product for subsequent_{.} drying, whereby the milk powders are obtained.

In a further embodiment of the present invention, in the scope of which whole milk powders are to be obtained, the cream separated in step (a) is added to the permeate again. It is crucial that the skim milk—and not the whole milk—is subjected to microfiltration. If one would refrain from separating the cream, the high fat load would lead to a clogging of the pores of the filtration membranes. As also the cream may still contain bacteria it is subjected to thermal treatment for a period of between 1 and 10, preferably, between 3 and 5 seconds at temperatures of from 85 to 138° C. before combining it with the permeate. The high temperatures are not significant at this point, as the cream only contains lipids and no thermally sensitive proteins.

After thermal treatment, the heated concentrate is processed to a dry powder. Suitable methods are belt drying, freeze drying and, especially, spray-drying.

The powders usually contain a residual moisture of 1 to 5, preferably, 2 to 3% by weight, in which the fat is more or less evenly distributed in the fat-free dry substances, i.e., proteins, sugars and salts in the form of enclosures. Before spraying, also other additives may be added to the homogenized concentrates, such as, for example, lecithins or food emulsifiers [EP 1314367 A1, Nestle]

### INDUSTRIAL APPLICATION

Two further forms of embodiment of the present invention relate, on the one hand, to low-bacteria low-heat skim milk powders and to low-bacteria low-heat whole milk powders, which each have a whey protein nitrogen index of above 2, preferably in the range from 3 to 7.5 and, particularly, in the range from 5 to 7, on the other.

The skim milk powders are obtained by
(a) removing solids from the raw milk using known methods, separating the cream,
(b) subjecting the skim milk such obtained to microfiltration,
(c) pasteurizing the permeate such obtained,
(d) concentrating the pasteurized permeate such obtained to a dry mass of 30 to 50% by weight, discarding the retentate.
(e) subjecting the concentrate such obtained to thermal treatment for a period of at least 15 and, preferably, from 15 to 20 seconds at a temperature of at least 72 and, preferably, 72 to 80° C., and

(f) processing the thermally treated product such obtained to obtain a dry powder.

The whole milk powders are obtained the same way, it is merely that the cream separated in step (a) is—as explained above—firstly subjected to high-heat treatment before adding it to the permeate obtained in the microfiltration process. In this case, the preferred WPNI is between 5 and 6.5.

### EXAMPLES

### Comparison Example V1

Solids were removed from raw milk in a method known in itself, then the milk was pasteurized and skimmed such that a skim milk with a dry mass of about 9% by weight was obtained. Said skim milk was gently evaporated, yielding a dry mass of ca. 40% by weight. The concentrate such obtained had a WPNI of 6.1 and was subjected to high-heat treatment at 120° C. for a period of about 5 seconds, thus destroying spores and any other bacteria. A bacteria-free concentrate was obtained, which was then sprayed using a spray tower. A practically bacteria-free high-heat skim milk powder with a WPNI of only 1.3 was obtained.

### Comparison Example V2

Example V1 was repeated; instead of a high-heat treatment at 105° C., however, thermal treatment was carried out at 70° C. for 5 seconds as well. After spraying, a low-heat skim milk powder with a WPNI of 5.9 was obtained, which, however, was contaminated by bacteria and thus only suitable for consumption to a limited degree.

### Example 1

### Production of a Low-Bacteria Skim Milk Powder

Example V2 was repeated, however, the skim milk was subjected—before the evaporization step—to microfiltration using a ceramic membrane with a pore size of between 1.3 to 1.5 μm.

The retentate was discarded, the permeate was evaporated and thermally treated at ca. 70° C. as described above, and sprayed. A low heat skim milk powder with a WPNI of 6.8 was obtained, which was practically bacteria-free.

### Example 2

### Production of a Low-Bacteria Whole Milk Powder

Solids were removed from raw milk using a method known in itself, the milk was pasteurized and skimmed such that a skim milk with a dry mass of ca. 9% by weight was obtained. It was subjected to a microfiltration, as described in Example 1, then the permeate was further processed. The cream obtained in the skimming process was subjected to high-heat treatment at 125° C. and again added to the permeate such that a whole milk was obtained, which, again was thermally treated at 70° C. and sprayed. A low heat whole milk with a WPNI of 6.3 was obtained, which was practically bacteria-free.

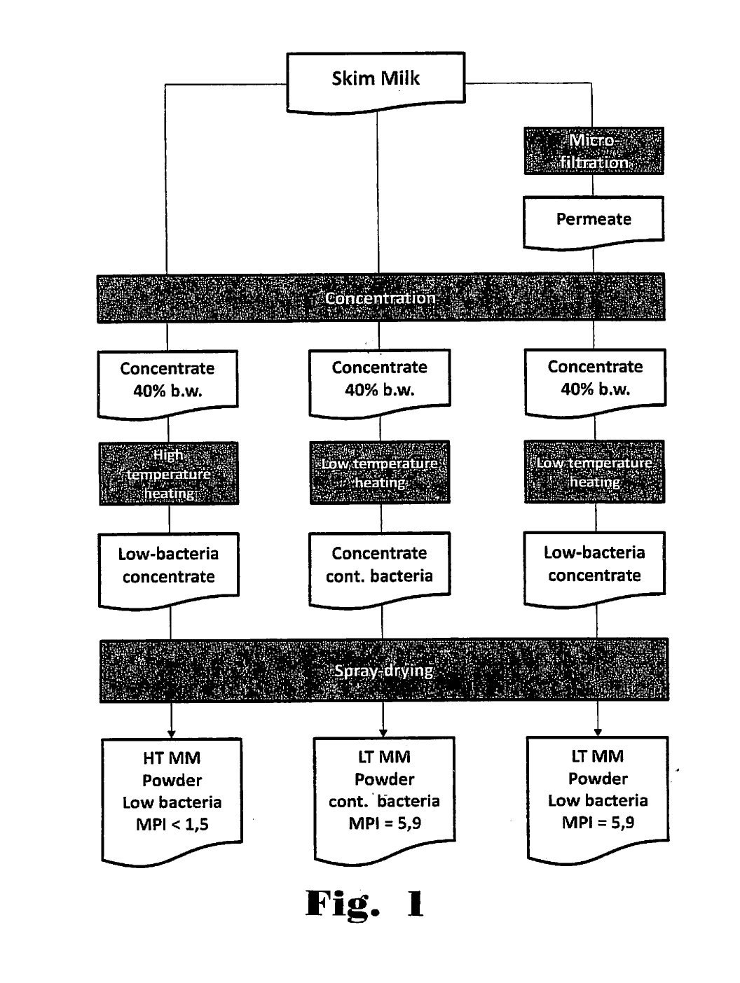

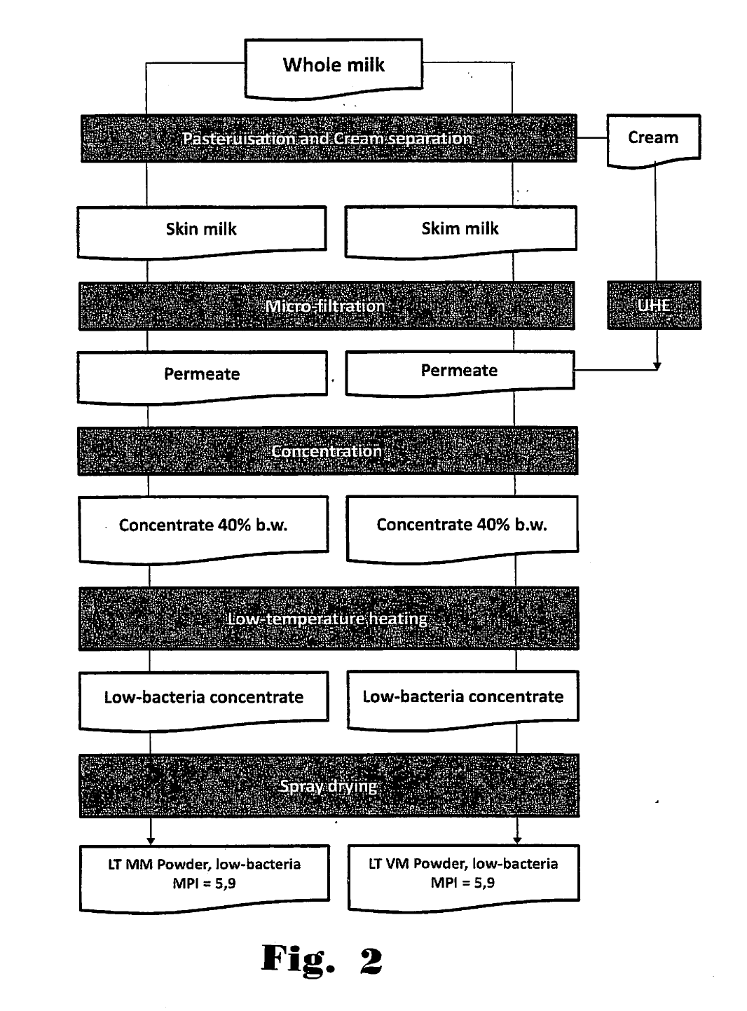

Examples V1, V2 and 1 are juxtapositioned to a flow diagram in FIG. 1. FIG. 2 represents the differences in the production of skim milk and whole milk powders.

1. A process for the production of low-bacteria whole milk powders having a whey protein nitrogen index (WPNI) of at least 2, wherein
(a) solids are removed from raw milk in a method known in itself, followed by a separation of the cream,
(b) the skim milk such obtained is subjected to microfiltration,
(c) the permeate such obtained is pasteurized,
(d) the pasteurized permeate such obtained is concentrated to a dry mass of from 30 to 50% by weight, discarding the retentate,
(e) the cream separated in step (a) is subjected to ultra-high heat treatment and added to the permeate again before heat treatment,
(f) the concentrate such obtained is subjected to thermal treatment for a period of at least 15 seconds at a temperature of at least 72° C., and
(g) the thermally treated product such obtained is processed to obtain a dry powder.

2. The process of claim 1, wherein said microfiltration is performed by a membrane having a pore diameter of from 1.1 to 2 μm,.

3. The process of claim 2, wherein said microfiltration is performed by a membrane having a pore diameter of from 1.3 to 1.5 μm.

4. The process of claim 1, wherein said microfiltration is performed at temperatures in the range of from 20 to 30° C.

5. The process of claim 1, wherein a ceramic membrane is used.

6. (canceled)

7. The process of claim 1, wherein the cream is subjected to a thermal treatment for a period of from 1 to 10 seconds at a temperature of from 85 to 145° C.

8. The process of claim 1, wherein the concentrate is processed to a dry powder by spraying.

9-11. (canceled)

12. A low-bacteria low-heat whole milk powder, obtainable according to the process of claim 1.

13. The powder of claim 12, wherein it has a WPNI in the range of from 3 to 7.5.

14. The powder of claim 12, wherein it has a WPNI in the range of from 5 to 6.5.
